(19) United States
(12) Patent Application Publication
(10) Pub. No.: US 2020/0179192 A1
(43) Pub. Date: Jun. 11, 2020

(54) BACKBOARD HAVING A TILTABLE ASSEMBLY

(71) Applicants: Michael D. Keating, Cibolo, TX (US); Eric C. Holt, New Braunfels, TX (US)

(72) Inventors: Michael D. Keating, Cibolo, TX (US); Eric C. Holt, New Braunfels, TX (US)

(21) Appl. No.: 16/696,292

(22) Filed: Nov. 26, 2019

Related U.S. Application Data
(60) Provisional application No. 62/772,303, filed on Nov. 28, 2018.

(51) Int. Cl. A61G 1/04

(52) U.S. Cl. CPC A61G 1/04

(57) ABSTRACT

A backboard is a device for the manual transport of a patient in need of medical care. The backboard with a tiltable assembly has a rigid body with an adjustable tilt assembly engaged to the upper portion. The adjustable tilt assembly is capable of being set in various positions, and is configured to elevate the torso of an accident victim. It allows first responders to have a consistent way to elevate a patient's head and/or torso in the CPR process (or other medical procedure) while the patient is still on the backboard and being transported. Because the elevation has been shown to increase the chance of the return of spontaneous circulation.

This application is based upon and claims priority from U.S. Provisional application Ser. No. 62/772,303, which is incorporated herein by reference.

### BACKGROUND OF THE INVENTION

### Field of the Invention

Applicants' invention relates to a device for the manual transport of a patient in need of medical care. More particularly, it relates to a backboard capable of being configured to elevate the torso of an accident victim.

### Background Information

Manual patient transport devices typically include stretchers, litters, backboards or longboards. They are used to move a patient away from a danger or disaster zone, accident area or fire. However, most first responders do not have a consistent way to elevate a patient's head and/or torso in the CPR process (or other medical procedure), which elevation proven to increase return of spontaneous circulation.

### SUMMARY OF THE INVENTION

A device to manually transport patients requiring medical care, the device comprising: a rigid body having a top surface, the top surface having a top surface plane, a bottom surface, a top side wall and a bottom side wall, and a left side wall and a right side wall, and a perimeter comprising the four side walls; the body having a body length, a body width, and a body thickness; the top surface of the body having an upper portion and a lower portion, the upper portion defined by an imaginary axis transverse to a longitudinal axis defining the body length of the body, the upper portion being at least 40 to 60% of the length, the upper portion having an upper portion plane and the lower portion having a lower portion plane; further including an adjustable tilt assembly engaged to the upper portion, the adjustable tilt assembly having an outer member and a support assembly to adjustably locate the outer member at an angle with respect to the lower portion plane, the adjustable tilt assembly capable of being set in a first position, where the outer member is parallel with the lower portion plane, and a second position where the outer member is tilted with respect to the lower portion plane; wherein, in some embodiments, in the first position, the body has a thickness in the range of ¾ inch to 3 inches; a weight in the range of about 9 to 24 pounds; a length in the range of 5 feet to 7 feet; a width in the range of 1 to 2½ feet; and multiple hand holes in the right and left side walls; and wherein the outer member is in the lower portion plane when in the first position.

A device to transport pediatric patients requiring medical care, the device comprising: a rigid body having a top surface, the top surface having a top surface plane, a bottom surface, a top side wall and a bottom side wall, and a left side wall and a right side wall, and a perimeter; the body having a length, a width, and a thickness; the top surface of the body having an upper portion and a lower portion, the upper portion defined by an imaginary axis transverse to a longitudinal axis defining the body length of the body, the upper portion being at least 40 to 60% of the length, the upper portion having an upper portion plane and the lower portion having a lower portion plane; further including an adjustable tilt assembly engaged to the upper portion, the adjustable tilt assembly having an outer member and a support assembly to adjustably locate the outer member at an angle with respect to the lower portion plane, the adjustable tilt assembly capable of being set in a first position, where the outer member is parallel with the lower portion plane, and a second position where the outer member is tilted with respect to the lower portion plane; wherein, in some embodiments, in the first position, the body has a thickness in the range of ¾ inch to 3 inches; a weight in the range of 4 to 18 pounds; a length in the range of 2 feet to 5 feet; a width in the range of 1 foot to 2½ feet; and multiple hand holes in the right and left side walls.

A method of performing CPR on a patient requiring medical care comprising: providing a rigid body having a top surface, the top surface having a top surface plane, a bottom surface, a top side wall and a bottom side wall, and a left side wall and a right side wall, and a perimeter comprising the four side walls; the body having a body length, a body width, and a body thickness; the top surface of the body having an upper portion and a lower portion, the upper portion defined by an imaginary axis transverse to a longitudinal axis defining the body length of the body, the upper portion being at least 40 to 60% of the length, the upper portion having an upper portion plane and the lower portion having a lower portion plane; further including an adjustable tilt assembly engaged to the upper portion, the adjustable tilt assembly having an outer member and a support assembly to adjustably locate the outer member at an angle with respect to the lower portion plane, the adjustable tilt assembly capable of being set in a first position, where the outer member is parallel with the lower portion plane, and a second position where the outer member is tilted with respect to the lower portion plane; wherein, in the first position, the body has a thickness in the range of ¾ inch to 3 inches; a weight in the range of 9 to 25 pounds; a length in the range of 5 feet to 7 feet; a width in the range of 1 to 2½ feet; and multiple hand holes in the right and left side walls; placing the device in the first position; positioning the patient such that his torso is on the outer member; pivoting the outer member to an angle between 10° and 45°; and performing CPR.

### BRIEF DESCRIPTION OF THE DRAWINGS

FIG. 1 is a perspective view of the top of an embodiment of Applicant's body board.

FIG. 1a is a perspective view of the bottom of Applicant's body board.

FIG. 2 is a close-up perspective view of the adjustable tilt assembly in an up or use position.

FIG. 2a is another view of an embodiment of the adjustable tilt assembly in an up or use position.

FIG. 3 is a close-up perspective view of the cavity of an embodiment of Applicant's body board.

FIG. 4 is a close up detailed perspective view of the manner in which the support assembly and the leg assembly engage one another when the adjustable tilt assembly is in a use or an up position.

FIG. 5 is a cross-sectional partial view of a bias member of the leg assembly illustrated in FIG. 4.

FIG. 6 is a close-up perspective view of the adjustable tilt assembly in an up or use position.

FIGS. 7A and 7b are schematic illustrations of Applicant's body board pointing out dimensions and locations of body portions.

FIGS. 8A and 8B illustrate alternate preferred embodiments of Applicant's present invention.

DETAILED DESCRIPTION OF
THE PREFERRED EMBODIMENT

| Ref. | Element |
|---|---|
| 10 | Backboard |
| 10a | Alternate backboard |
| 12 | Body |
| 14 | Top surface |
| 14a | Outer member |
| 16 | Left side |
| 18 | Right side |
| 20 | Bottom surface |
| 22 | Handles |
| 24 | Lower portion |
| 26 | Upper portion |
| 28 | Longitudinal leg slot |
| 30 | Bottom side wall |
| 31 | Top side wall |
| 32 | Adjustable tilt assembly |
| 33 | Hinge line |
| 34 | Cavity |
| 35 | cavity perimeter frame |
| 36 | Hinges |
| 37 | holes |
| 40 | Support assembly |
| 42 | Leg locator assembly |
| 44 | Leg locator assembly |
| 46 | Legs |
| 48 | Legs |
| 50 | Heel |
| 51 | leg portion |
| 52 | Foot |
| 54 | Transverse member |
| 56 | Locator member |
| 58 | Locator member |
| 60 | Inboard channel |
| 61 | tube |
| 62 | Inboard channel |
| 63 | captive spring |
| 64 | Receiving hole |
| 66 | Receiving hole |
| 70 | Stowed internal strap |
| 72 | Stowed internal strap |
| 73 | Other strap |
| 74 | Strap |
| 78 | Retrofit tilt assembly |
| 82 | Hinge |
| 84 | Frame |
| 84a | Feet |
| 86 | Fastener |

Unless otherwise specifically noted, articles depicted in the drawings are not necessarily drawn to scale.

Throughout this disclosure, a hyphenated form of a reference numeral refers to a specific instance of an element and the un-hyphenated form of the reference numeral refers to the element generically or collectively. Thus for example, widget 12-1 would refer to a specific widget of a widget class 12, while the class of widgets may be referred to collectively as widgets 12 and any one of which may be referred to generically as a widget 12.

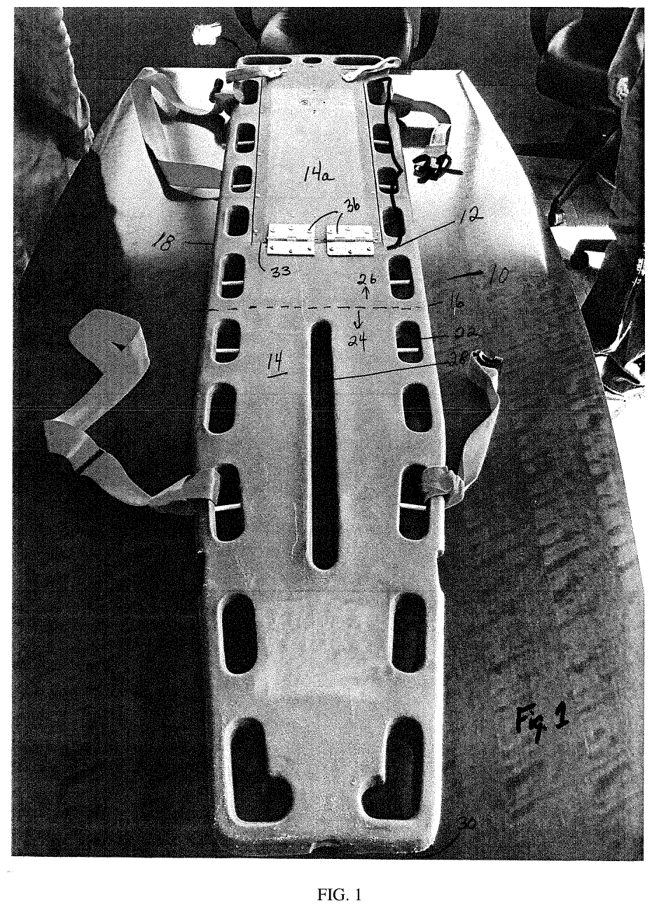

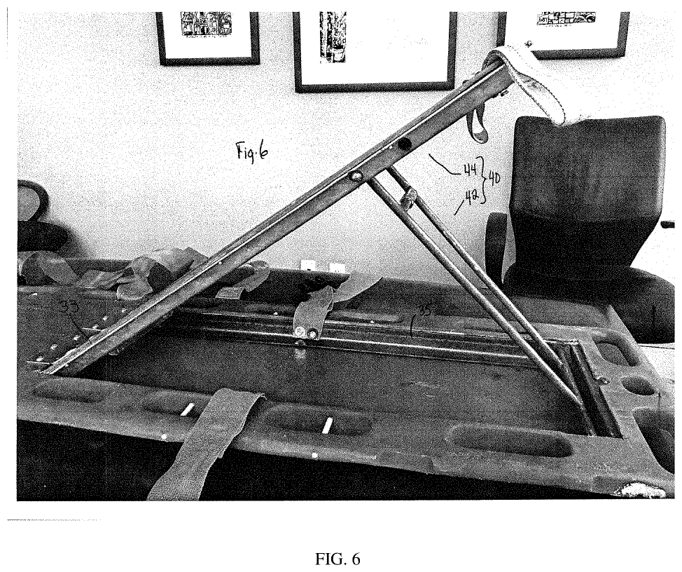

Referring to the figures, FIGS. 1-6 illustrate a backboard 10 that is similar in most respects to prior art backboards that have been used for many years by first responders (such as firemen) to transport accident victims. However, Applicant's improved backboard 10 includes an adjustable tilt assembly as set forth in more detail below that allows the victims torso and head together on a flat surface to be elevated with respect to the victim's lower body so as to more successfully carry out emergency resuscitation procedures such as cardiopulmonary resuscitation (“CPR”), patient transport and position of head/blunt trauma and altered consciousness, neurological complaints numbness or motor weakness, spinal tenderness or pain, anatomic injury of the spine, high energy mechanism of injury, distracting injury, respiratory compromise or difficulty breathing, inability to communicate, drug or alcohol intoxication, stroke hydrocephalus, those with heart conditions, such as chronic obstructive pulmonary disease (“COPD”) or congestive heart failure (“CHF”), and those that have arthritis or other problems causing kyphosis. That is to say, differing from the prior art backboards, Applicant's backboard 10 has, in some embodiments, an upper portion that, in a use position, is elevated at an angle with respect to a stationary lower portion.

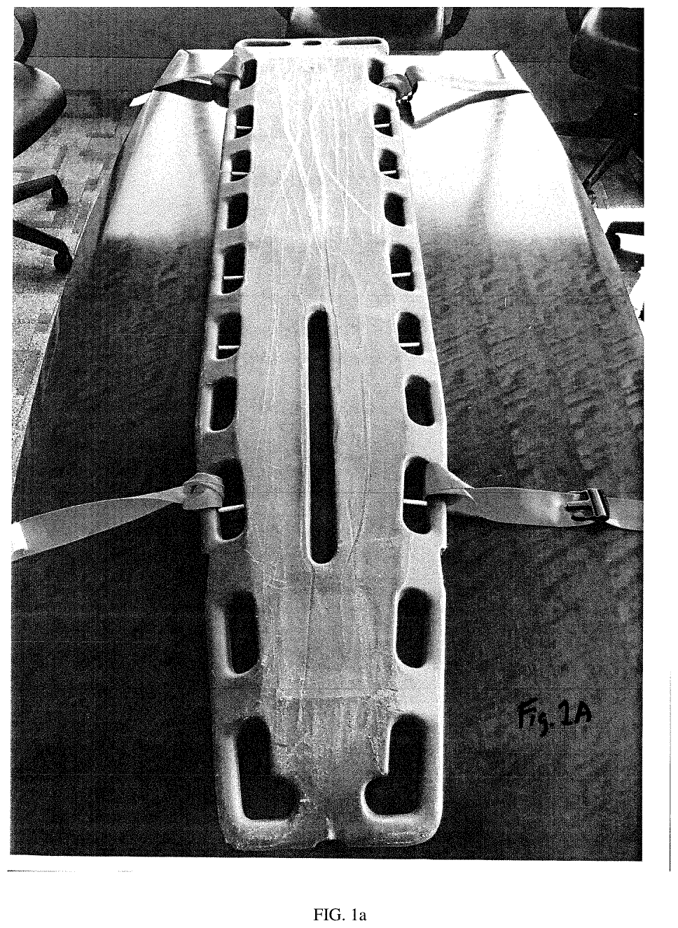

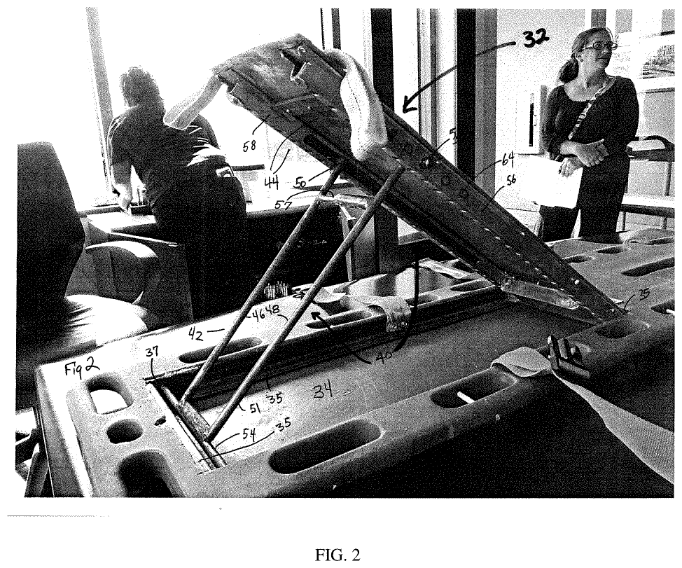

FIGS. 1 and 2 illustrate backboard 10 comprising a body 12 having a upper portion 26 and a lower portion 24. Body 12 includes a top surface 14 having an outer member or outer member 14a in an upper portion 26. Body 12 may include left side 16 and right side 18 (patients left, patients right) and a bottom surface 20 (see FIG. 1A). Body 12 may include top side wall 31 and bottom side wall 30. As is known in the prior art, carrying handles 22 may be provided around a perimeter of the body to act as handholds for the first responders. In some embodiments, a longitudinal slot 28 is provided in lower portion 24.

Applicant's backboard 10 includes an adjustable tilt assembly 32, which elevates outer member 14a. A non-pivotable body portion has a cavity 34, the cavity provided for, and some embodiments, in a first position locating and concealingly enclosing a support assembly 40 and a leg locator assembly 42 of adjustable tilt assembly 32, and in some embodiments, straps. In some embodiments, in a first position pivot portion or outer member 14a of top surface 14 is flush with the non-pivot portion of top surface 14 (see FIG. 1). Support assembly 40 is designed to support outer member 14a in a tilt position with respect to the non-pivot (stationary) portion of the top surface (compare FIGS. 1 and 2).

FIG. 1 illustrates a non-tilt, first or stowed position wherein the outer member 14a is flush (in the same plane) with the non-pivot portion of top surface 14.

In FIG. 2, the adjustable tilt assembly 32 has located outer member 14a in tilt, second or use position, wherein a victim, whose waist is approximately located at a hinge line 33 may have his/her torso elevated to an angle, in some embodiments, between 26 and 34° (in some embodiments, 10-45°).

Adjustable tilt assembly 32 comprises outer member 14a and hinges 36, which may be external or internal (i.e., hidden), external hinges are shown. Support assembly 40 includes leg assembly 42 and leg locator assembly 44. Leg assembly 42 provides support to hold the outer member 14a at a preselected angle with respect to the non-pivot portion of the top surface. Leg locator assembly 44 is attached to the underside of outer member 14a and receives leg assembly 42, in some embodiments, removably and lockably.

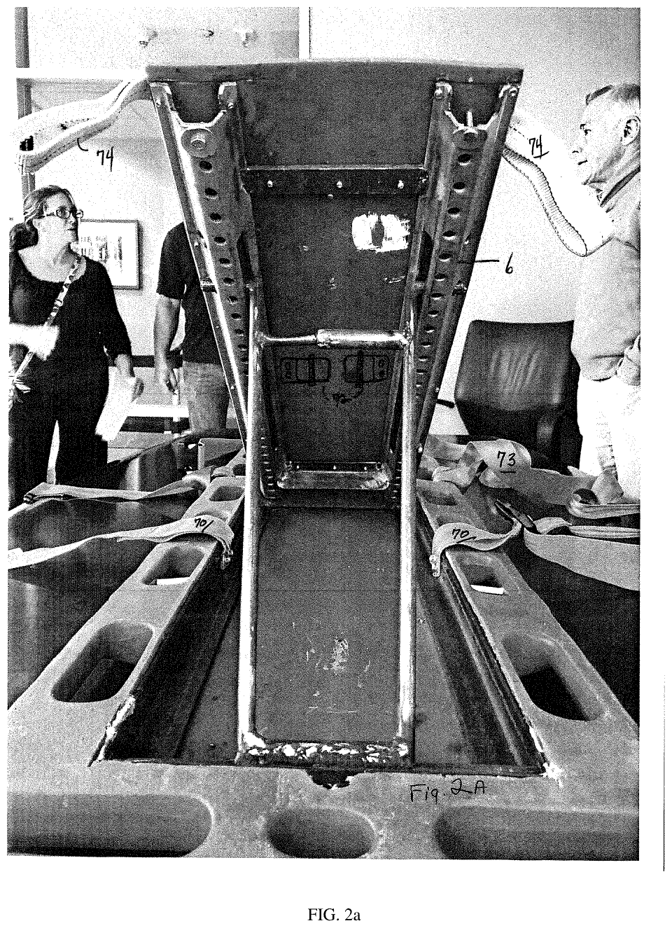

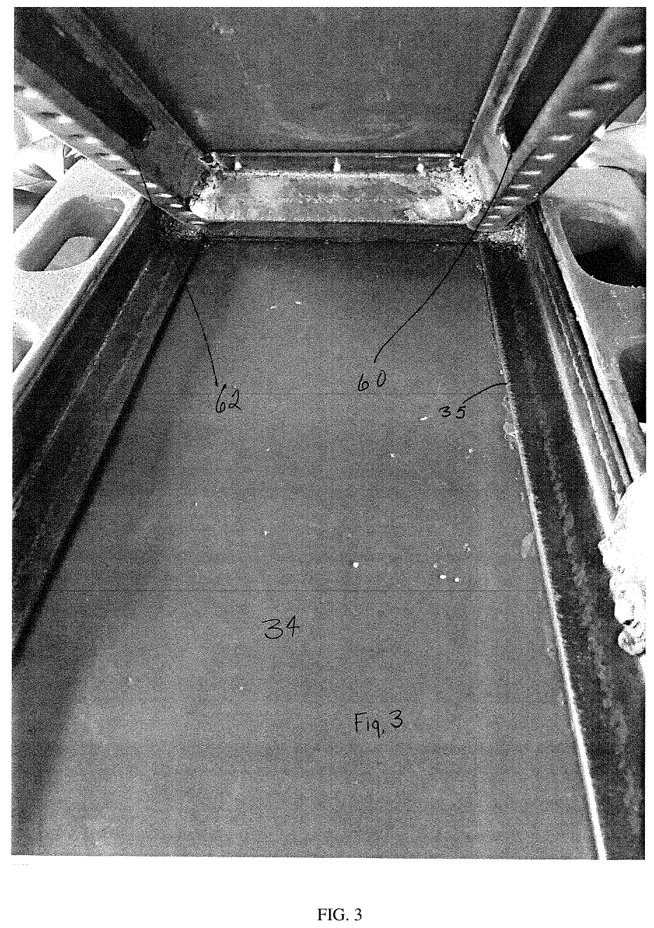

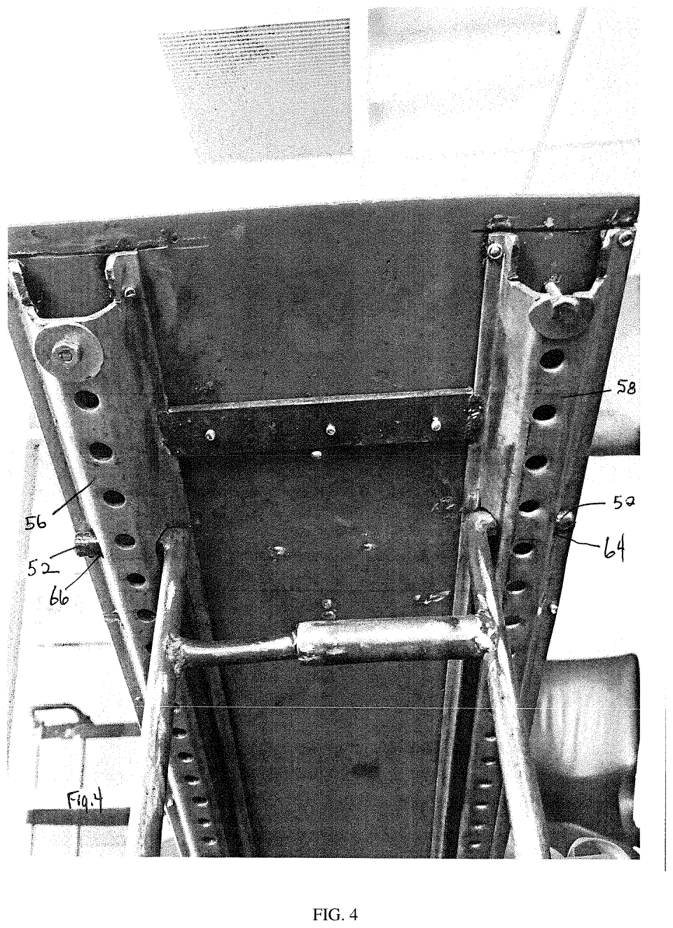

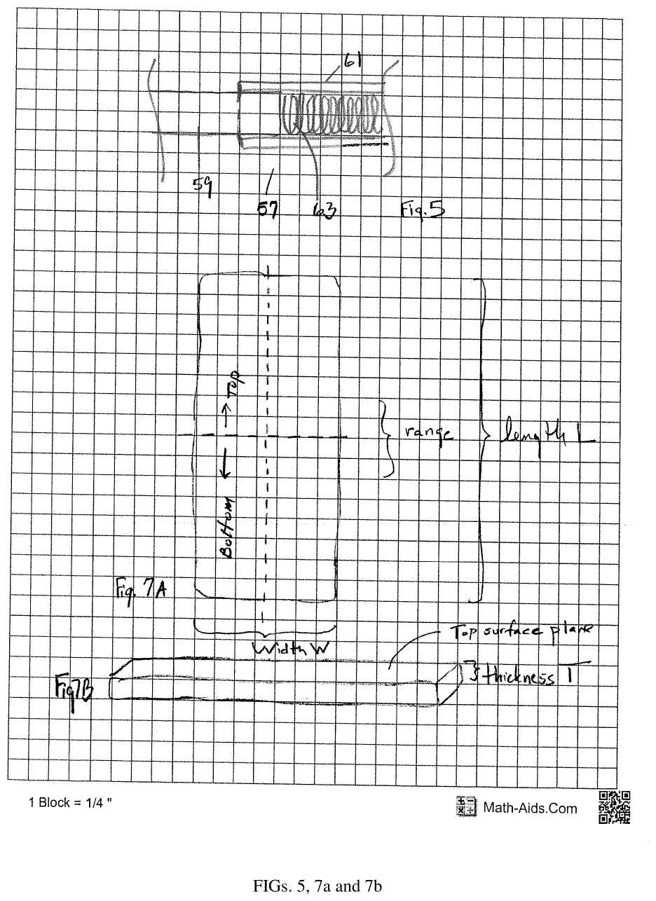

Turning now to leg assembly 42, it is seen to have at least one leg, here legs two, 46/48. Legs comprise a leg portion 51, a heel 50 and a foot portion 52. The removed end of leg portion 51, opposite the heel and foot may engage a transverse member 54, which in turn engages a cavity perimeter frame 35 which may have top, bottom, left and right side members as seen in FIGS. 2, 2A, and 3. In some embodiments, transverse member 54 is pivotally mounted in holes 37 of the left and right side members of cavity perimeter member 35, as seen in FIG. 2. Legs 46/48 may be somewhat flexible (like mild steel or aluminum) and biased outward by biased member 57 which, as seen in FIG. 5, may include a rod 59 mounted to one of the two legs, a tube 61 mounted to the other leg, dimensioned to telescopically receive rod 59, and a captive spring 63, such as a coil spring. This will bias the two legs outward near the foot end thereof to lock into leg locator assembly 44 (see FIG. 4).

Leg locator assembly 44, as seen in FIGS. 2A, 3 and 4, is seen to have locator members 56 and 58 mounted to the underside of outer member 14a. Each of the locator members may have an inboard channel 60 and 62 and receiving holes 64/66. As seen in FIGS. 2 and 4, foot 52 is dimensioned to slide in the inboard channels, and the toe end of the foot may engage receiving holes 64/66 and may be biased outward by biased member 57 to lockingly engage the multiple holes and hold the outer member 14a at a pivoted, angular position or use position, with respect to the rest of the board.

Applicant's backboard may include stowed internal straps 70, here seen to be mounted on cavity perimeter frame 35. In addition, there may be stowed internal straps 72 that are mounted on the outer member 14a, as well as stowed internal straps 70, stowed internal straps 72 and other straps 73, such as those mounted to body 12 (see FIG. 2A), may be used to wrap around the patient's torso and/or arms to stabilize the patient wall the board is in the tilt position. Straps 74 may be attached near a removed end of outer member 14a to help lift the patient's torso and head. Straps may be fabric and may be retractable and include adjustment buckles.

All of the backboard or any part or assembly of the backboard may be made from one or more of the following: plastic, metal, wood, composite, stainless steel, aluminum or aluminum alloy, poly resin or rubber. Any surface, external or internal, may be fully or partly covered with rubber, neoprene or any protective health or safety covering. The outer member of the tiltable assembly may include a non-slip pad to hold the torso in a tilted or flat position. Velcro or other adhesion materials may be used. In some embodiments, the materials used in the construction of the backboard are x-ray translucent. In some embodiments, the materials are selected so that the backboard is buoyant (can float in water). In some embodiments, the dimensions are preferably about length 72 inches, width 18 inches, and thickness 1½ inch. While the board in the preferred embodiment is rigid, it may be foldable so as to fold in half for fitting in confined spaces.

A pre-attached or attachable head immobilization or cervical stabilization device may be used in conjunction with the present invention, including those manufactured by Kemp USA, Ferno or ITEC multi group head immobilizers.

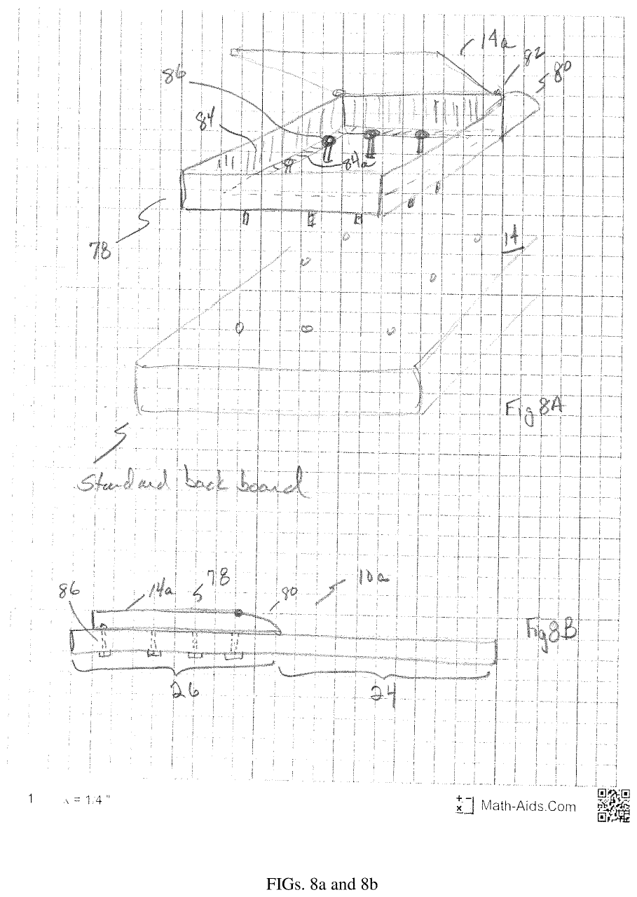

FIGS. 8A and 8B illustrate an alternate embodiment of backboard 10a, here featuring a portable, self-contained add-on retrofit tilt assembly 78 for retrofit to the flat upper surface of a standard backboard. Retrofit tilt assembly 78 includes outer member 14a hinged with hinges 82 to a frame 84, which may be made of four rectangular “L shaped” members welded or otherwise fixed to one another at the corners thereof. The L-shaped members may have feet 84a with multiple holes for the receipt of fasteners 86 there into, likewise there are multiple holes through a top portion 26 of a backboard to be retrofitted. FIG. 8B illustrates fasteners through fastener holes in the board engaged to nuts on the underside of the board to hold retrofit tilt assembly to the top portion. There may be a curved leading edge 84 for patient comfort that may be positioned at or about the lower back. Leg and leg locator assemblies are not shown, but are as in previous embodiments. As seen in FIG. 8B, retrofit tilt assembly 78 is low-profile, in some embodiments, about one and ½ to 2 inches in thickness. It may attach such that leading edge 84 is at the lumbar curve of the lower spine.

It should be noted that when “about” or “approximately” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities and the like used in the present specification and associated claims are to be understood as being modified in all instances by the terms “about” or “approximately.”

The term “substantially” and its variations are defined as being largely but not necessarily wholly what is specified as understood by one of ordinary skill in the art.

The terms “inhibiting” or “reducing” or any variation of these terms refer to any measurable decrease, or complete inhibition, of a desired result. The terms “promote” or “increase” or any variation of these terms includes any measurable increase, or completion, of a desired result.

The term “effective,” as that term is used in the specification and/or claims, means adequate to accomplish a desired, expected, or intended result.

The terms “a” or “an” when used in conjunction with the term “comprising” in the claims and/or the specification may mean “one,” but it is also consistent with the meaning of “one or more,” “at least one,” and “one or more than one.”

The term “each” refers to each member of a set, or each member of a subset of a set.

The terms “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

In interpreting the claims appended hereto, it is not intended that any of the appended claims or claim elements invoke 35 U.S.C. 112(f) unless the words “means for” or “step for” are explicitly used in the particular claim.

It should be understood that, although exemplary embodiments are illustrated in the figures and description, the principles of the present disclosure may be implemented using any number of techniques, whether currently known or not. The present disclosure should in no way be limited to the exemplary implementations and techniques illustrated in the drawings and description herein. Thus, although the invention has been described with reference to specific embodiments, this description is not meant to be construed in a limited sense. Various embodiments may include some, none, or all of the enumerated advantages. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention. Modifications, additions, or omissions may be made to the systems, apparatuses, and methods described herein without departing from the scope of the disclosure. For example, the operations of the systems and apparatuses disclosed herein may be performed by more, fewer, or other components in the methods described may include more, fewer, or other steps. Additionally, steps may be performed in any suitable order.

I claim:

1. A device to manually transport patients requiring medical care, the device comprising:
a rigid body having a top surface, the top surface having a top surface plane, a bottom surface, a top side wall and a bottom side wall, and a left side wall and a right side wall, and a perimeter comprising the four side walls; the body having a body length, a body width, and a body thickness; the top surface of the body having an upper portion and a lower portion, the upper portion defined by an imaginary axis transverse to a longitudinal axis defining the body length of the body, the upper portion being at least 40 to 60% of the length, the upper portion having an upper portion plane and the lower portion having a lower portion plane;
further including an adjustable tilt assembly engaged to the upper portion, the adjustable tilt assembly having an outer member and a support assembly to adjustably locate the outer member at an angle with respect to the lower portion plane, the adjustable tilt assembly capable of being set in a first position, where the outer member is parallel with the lower portion plane, and a second position where the outer member is tilted with respect to the lower portion plane;
wherein, in the first position, the body has a thickness in the range of ¾ inch to 3 inches; a weight in the range of 9 to 25 pounds; a length in the range of 5 feet to 7 feet; a width in the range of 1 to 2½ feet; and
multiple hand holes in the right and left side walls.

2. The device of claim 1, wherein the outer member is in the lower portion plane when in the first position.

3. A device to manually transport pediatric patients requiring medical care, the device comprising:
a rigid body having a top surface, the top surface having a top surface plane, a bottom surface, a top side wall and a bottom side wall, and a left side wall and a right side wall, and a perimeter; the body having a length, a width, and a thickness; the top surface of the body having an upper portion and a lower portion, the upper portion defined by an imaginary axis transverse to a longitudinal axis defining the body length of the body, the upper portion being at least 40 to 60% of the length, the upper portion having an upper portion plane and the lower portion having a lower portion plane;
further including an adjustable tilt assembly engaged to the upper portion, the adjustable tilt assembly having an outer member and a support assembly to adjustably locate the outer member at an angle with respect to the lower portion plane, the adjustable tilt assembly capable of being set in a first position, where the outer member is parallel with the lower portion plane, and a second position where the outer member is tilted with respect to the lower portion plane;
wherein, in the first position, the body has a thickness in the range of ¾ inch to 3 inches; a weight in the range of 9 to 25 pounds; a length in the range of 2 feet to 5 feet; a width in the range of 1 foot to 2½ feet; and
multiple hand holes in the right and left side walls.

4. A method of performing CPR or other emergency medical procedure on a patient requiring medical care comprising:
providing a manual patient transport device comprising a rigid body having a top surface, the top surface having a top surface plane, a bottom surface, a top side wall and a bottom side wall, and a left side wall and a right side wall, and a perimeter comprising the four side walls; the body having a body length, a body width, and a body thickness; the top surface of the body having an upper portion and a lower portion, the upper portion defined by an imaginary axis transverse to a longitudinal axis defining the body length of the body, the upper portion being at least 40 to 60% of the length, the upper portion having an upper portion plane and the lower portion having a lower portion plane;
further including an adjustable tilt assembly engaged to the upper portion, the adjustable tilt assembly having an outer member and a support assembly to adjustably locate the outer member at an angle with respect to the lower portion plane, the adjustable tilt assembly capable of being set in a first position, where the outer member is parallel with the lower portion plane, and a second position where the outer member is tilted with respect to the lower portion plane;
wherein, in the first position, the body has a thickness in the range of ¾ inch to 3 inches; a weight in the range of 9 to 25 pounds; a length in the range of 5 feet to 7 feet; a width in the range of 1 to 2½ feet; and multiple hand holes in the right and left side walls;
placing the device in the first position;
positioning the patient such that his torso is on the outer member;
pivoting the outer member to an angle between 10° and 45°; and
performing CPR or other emergency medical procedure.

5. A method of extraction of a patient from danger zone, such as a wrecked vehicle, the method comprising the steps of:
providing a manual patient transport device comprising a rigid body having a top surface, the top surface having a top surface plane, a bottom surface, a top side wall and a bottom side wall, and a left side wall and a right side wall, and a perimeter comprising the four side walls; the body having a body length, a body width, and a body thickness; the top surface of the body having an upper portion and a lower portion, the upper portion defined by an imaginary axis transverse to a longitudinal axis defining the body length of the body, the upper portion being at least 40 to 60% of the length, the upper portion having an upper portion plane and the lower portion having a lower portion plane;
further including an adjustable tilt assembly engaged to the upper portion, the adjustable tilt assembly having an outer member and a support assembly to adjustably locate the outer member at an angle with respect to the lower portion plane, the adjustable tilt assembly capable of being set in a first position, where the outer member is parallel with the lower portion plane, and a second position where the outer member is tilted with respect to the lower portion plane;
setting the adjustable tilt assembly in a first position;
moving the patient to the manual patient transport device;
performing an emergency procedure on the patient;
moving the adjustable tilt assembly to a lower position; and
transporting the patient on the manual patient transport device to a hospital or ambulance.
